(19) United States
(12) Patent Application Publication
(10) Pub. No.: US 2005/0175963 A1
(43) Pub. Date: Aug. 11, 2005

(54) Cosmetic prosthesis

(76) Inventor: Craig A. Bruce, Encinitas, CA (US)

Correspondence Address: US CORPORATIONS, INC., 630 NEPTUNE AVE., ENCINITAS, CA, 92024, US

(21) Appl. No.: 10/376,709

(22) Filed: Feb. 27, 2003

(51) Int. Cl. A61C 5/00

(52) U.S. Cl. 433/140

(57) ABSTRACT

A cosmetic prosthesis designed to provide non-invasive, removable enhancement of upper and lower lip, being intended to contour and push the facial skin around the mouth and jaw outward, reducing the appearance of wrinkles or aging lines.

### CROSS-REFERENCE TO RELATED APPLICATION

Not applicable

### STATEMENT REGARDING FEDERALLY SPONSORED RESEARCH OR DEVELOPMENT

Not applicable

### REFERENCE TO SEQUENCE LISTING

Not applicable

### BACKGROUND

Since the dawn of civilization or since ancient Greece, people have searched for the ‘fountain of youth’ or a manner in which to turn back the hands of time and appear more youthful. As we age, lines and wrinkles become more numerous and prominent, particularly in the face causing additional and pronounced wrinkling of the mouth area. The area of skin surrounding ones mouth is highly susceptible to such wrinkles and aging lines due to the amount of fat cells present in the area and the continual growth of the nose and chin. This is the focus of our device. As we age our teeth and gums also begin to recede, causing additional wrinkling to the mouth and lip area. Smoking, sun exposure and other environmental conditions also add to the aging and wrinkling of the face.

During the aging process, the nose continues to grow putting continual pressure on the upper lip causing ones teeth to show less and less during conversation and smiling. The prosthesis can restore the upper lip position allowing a more youthful appearance of the lower face addressing the upper and lower lip area. The prosthesis width or thickness will determine the amount of lip lift achieved.

As we age, our teeth and gums also begin to recede into the mouth. This movement of the teeth causes additional wrinkling around the mouth area as the skin folds sag without support, a condition which is exaggerated with the loss of skin elasticity, a condition that inevitably accompanies aging. The prosthesis can replace the area once filled by the now receding gums pushing the lips and skin out, removing the appearance of the wrinkles.

Ageing can also lead to a downward turn of the corners of the mouth (frown) that occurs when facial connective tissues and muscles (especially the Zygomaticus muscles, and the Levator Anguli Oris muscle) loosen with age. The device enlarged above and just lateral to the oral commissural (corner of the mouth) would help to elevate the corners of the mouth, and make and upward movement of the corners of the mouth.

Additional conditions that can be improved by the prosthesis:
Lipstick Lines (peri-oral rhytids)
Bell's (or Facial Nerve) palsy
Long upper lips that obscure the upper lips (i.e. can slightly elevate upper lip)
Hemi facial microsomia: This is when one half of the face doesn't grow as much as the other side. The prosthesis can be used to make the smile more symmetric.

It is an object of the present invention to create a cosmetic prosthesis which is easy and inexpensive to prepare, easy to install and remove, thus comfortably displacing the lips as to reduce facial wrinkles and ageing lines.

### DETAILED DESCRIPTION OF THE INVENTION

This invention relates to a cosmetic prosthesis for the mouth. The cosmetic prosthesis is useful to provide non-invasive enhancement of upper and/or lower lip contour for cosmetic purposes including the reduction or elimination of facial wrinkles and aging lines in the area. The prosthesis, which functions like a swelling of the patients original gums, is custom fitted for each patient based on impression models. The prosthesis consists of one or two customizable space filling components which rest in the vestibule of the mouth underlying the upper lip and cheek. These space filling sub units or prosthesis rest on either side of the frenulum; the exact distance between the frenulum and these space filling components is variable depending upon the exact contour desired in a given patient.

The cosmetic prosthesis of the present invention overcomes in simple manner, invasive techniques of surgical implants placed into the lip areas and under the nose to reduce wrinkles and ageing lines. Construction is made possible by use of dental materials which are customizable and compatible with the gums.

The prosthesis may be removed from the mouth and cleaned effectively at any time desired. The prosthesis may be worn during eating or sleeping. An essential advantage of the prosthesis according to the invention must also be seen in the fact that it is inexpensive to prepare and does not require manipulations on healthy teeth for fitting or holding.

The cosmetic prosthesis of the invention is safely held in place by a clamping device molded onto the prosthesis which temporarily attaches to the molars.

The cosmetic prosthesis of the invention differs from prior inventions relating to gum atrophy or paradentosis as the cosmetic prosthesis can be made from similar materials, however the purpose and/or function of the current invention is not to protect, cover or fit to exposed areas of the teeth beneath, above or below the gum line. The primary function of the device is to fill the cavity within the mouth between the gums and the lips to dissipate facial wrinkles.

The cosmetic prosthesis of the invention differs from prior inventions relating to dentures or similar as the current invention does not cover the top of the gums. The current invention does not cover, protect, maintain or house teeth, prosthetic teeth or similar.

The cosmetic prosthesis of the invention differs from prior inventions relating to orthodontics as the invention does not alter of affect the occlusion of the teeth. The current invention does not alter, adjust or touch the teeth other than the clasping device which hold the prosthesis in place.

### ILLLUSTRATIONS

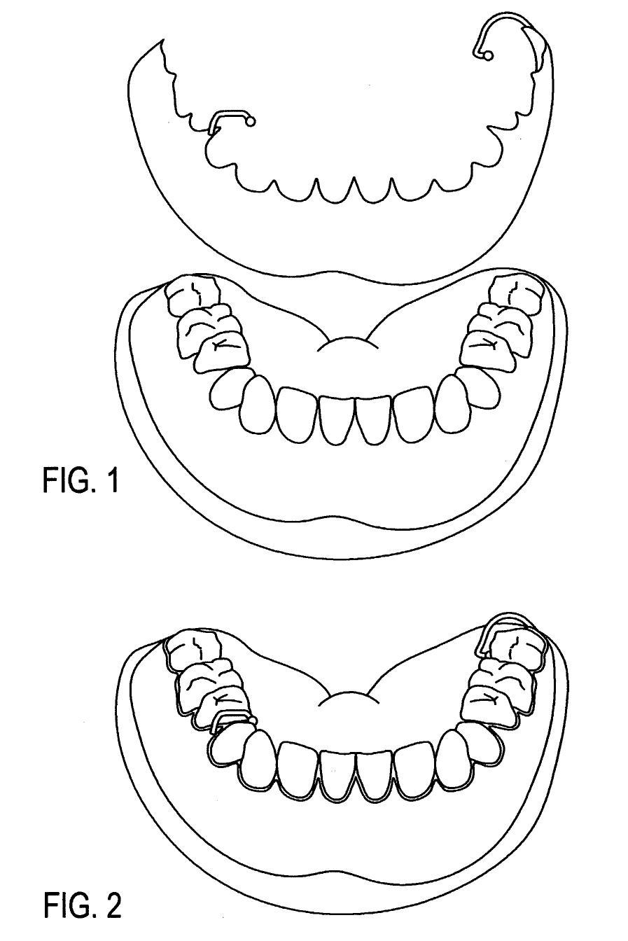

FIG. 1

The device off of the lower gums

FIG. 2

The device in place and on the lower gums

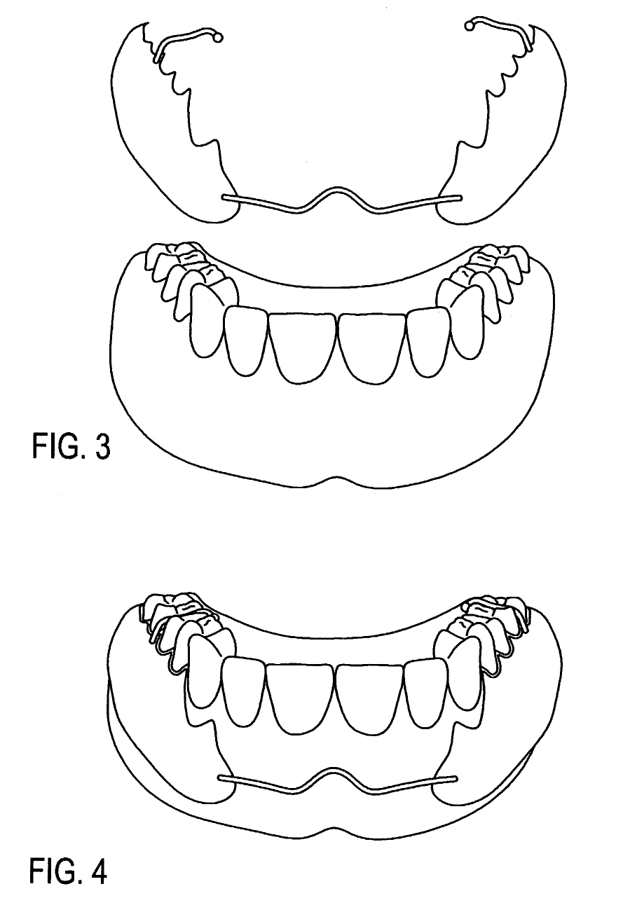

FIG. 3

The device off the upper gums

FIG. 4

The device on the upper gums

FIG. 1, shows the prosthesis and a typical lower jaw. The prosthesis, which replicates the shape and image of the gums, embodies an attachment wire which connects to the teeth to hold in place.

FIG. 2, shows the device placed over the gums and attached to the teeth. The prosthesis is colored and shaped to replicate the gums displacing the space between the gums and the lips.

FIG. 3, shows the upper lip prosthesis and the connecting wire which holds the right and left side of the prosthesis together. The figure also illustrates the connecting wire which helps hold the device firmly in place. The connecting wire is replaced with a formed clasp when plastic is used.

FIG. 4, shows the prosthesis in place over the gums of the upper lip area. The figure illustrates a clip placed between teeth in the rear of the mouth.

1. A cosmetic prosthesis, comprising of: a customizable space filling component which rest on the upper or lower gums against the under side of the lips pushing the lips outward to reduce facial wrinkles around the mouth.

2. A cosmetic prosthesis, according to claim 1 wherein the prosthesis varies in thickness according to the patients needs.

3. A cosmetic prosthesis, according to claim 1 wherein the prosthesis is fitted to the gums through dental impression techniques.

4. A cosmetic prosthesis, according to claim 1 wherein the prosthesis is attached to the teeth for stability.

5. A cosmetic prosthesis, according to claim 1, wherein the components are used to push or contour the lips outward.

6. A cosmetic prosthesis, according to claim 1 wherein the components are color matched to the patients gums.
